(19) United States
(12) Patent Application Publication
(10) Pub. No.: US 2008/0196845 A1
(43) Pub. Date: Aug. 21, 2008

(54) VISCOUS BRAKING DEVICE EQUIPPED WITH MONODIRECTIONAL MECHANISM, PARTICULARLY FOR MOSQUITO CURTAINS

(76) Inventor: Marco Zangirolami, Borgoticino (IT)

Correspondence Address: SHELDON MAK ROSE & ANDERSON PC, 100 Corson Street, Third Floor, PASADENA, CA, 91103-3842, US

(21) Appl. No.: 12/098,344

(22) Filed: Apr. 4, 2008

Related U.S. Application Data
(63) Continuation-in-part of application No. 10/892,036, filed on Jul. 14, 2004, now Pat. No. 7,360,736.
Application No. 10/892,036 is a continuation-in-part of application No. PCT/IT2002/000403, filed on Jun. 20, 2002.

(30) Foreign Application Priority Data
Jan. 14, 2002 (IT) TO02A000038

(51) Int. Cl. E06B 9/80; A47H 33/00

(52) U.S. Cl. 160/291; 160/405

(57) ABSTRACT

A monodirectional braking mechanism is disclosed, for use with a device for extending and retracting a sheet of material on a roller, the braking mechanism comprising: one or more than one housing containing viscous fluid, one or more that one rotor within the housing; a brake connected to the rotor and placed within the housing, the brake comprising a projecting pin; a braking spring wound around the pin of the brake and placed outside the housing; where the braking mechanism reduces the force or rate, or both the force and rate, of rotation of the roller as the roller is rotated in a second rotation direction but has substantially no effect on the force or rate of rotation of the roller when the roller is rotated in a first rotation direction; and where the first rotation direction is the reverse of the second rotation direction.

### CROSS-REFERENCE TO RELATED APPLICATION

This application is a continuation-in-part of U.S. patent application Ser. No. 10/892,036 entitled “Viscous Braking Device Equipped with Monodirectional Mechanism, Particularly for Mosquito Curtains,” filed on Jul. 14, 2004, which is a continuation-in-part of International Patent Application No. PCT/IT02/00403 entitled “Viscous Braking Device Equipped with Monodirectional Mechanism, Particularly for Mosquito Curtains,” filed on Jun. 20, 2002, which claims priority from Italian Patent Application No. TO2002A000038 entitled “Dispositivo di frenatura viscosa dotato di meccanismo monosenso, in particolare per zanzariere,” filed Jan. 14, 2002.

### BACKGROUND

There exist many devices for extending and retracting a sheet of cloth or other material on a roller. These devices include window shades and rollers for screening fabric, such as mosquito netting. In general, these devices comprise a hollow roller having a winding spring connected to one side. The material is wound around the roller to take up the smallest possible space when the device is in the retracted position. In the extended position, the material is unwound from the roller, and the winding spring is under high tension. When the device is to be returned to the retracted position, tension on the winding spring is released causing the roller to rotate and the material to wind around the roller. Disadvantageously, however, the high load on the winding spring can cause the roller to rotate so fast during retraction that the device can cause injury to the operator, and can also cause loud unpleasant noises.

Therefore, there is a need for a mechanism and a device for extending and retracting a sheet of material on a roller that is not associated with this disadvantage. Further, there is a need for a method of extending and retracting a sheet of cloth or other material on a roller that is not associated with this disadvantage.

### SUMMARY

According to one embodiment of the prevent invention, there is provided a monodirectional braking mechanism for use with a device for extending and retracting a sheet of material on a roller, where the braking mechanism comprises: one or more than one housing containing viscous fluid; one or more that one rotor within the housing; a brake connected to the rotor and placed within the housing, the brake comprising a projecting pin; a braking spring wound around the pin of the brake and placed outside the housing, where the braking mechanism reduces the force or rate, or both the force and rate, of rotation of the roller as the roller is rotated in a second rotation direction but has substantially no effect on the force or rate of rotation of the roller when the roller is rotated in a first rotation direction, and where the first rotation direction is the reverse of the second rotation direction.

According to another embodiment of the present invention, the viscous fluid comprises one or more than one high-viscosity oil.

According to another embodiment of the present invention, the viscous fluid comprises one or more than one grease.

According to another embodiment of the present invention, the rotor comprises a plurality of wings.

According to another embodiment of the present invention, the braking mechanism further comprises one or more than one holder for the viscous fluid within the housing. According to another embodiment of the present invention, the holder comprises two or more than two gaskets.

According to another embodiment of the present invention, the braking mechanism further comprises a speed multiplier connected to the rotor.

According to another embodiment of the present invention, there is provided a device for extending and retracting a sheet of material comprising: a roller; and a braking mechanism comprising one or more than one housing containing viscous fluid, one or more that one rotor within the housing, a brake connected to the rotor and placed within the housing, the brake comprising a projecting pin, a braking spring wound around the pin of the brake and placed outside the housing, where the braking mechanism reduces the force or rate, or both the force and rate, of rotation of the roller as the roller is rotated in a second rotation direction but has substantially no effect on the force or rate of rotation of the roller when the roller is rotated in a first rotation direction, and where the first rotation direction is the reverse of the second rotation direction.

According to another embodiment of the present invention, the device further comprises a system for holding the braking mechanism to a surface or object.

According to another embodiment of the present invention, the braking mechanism further comprises one or more than one drum adapted to be coupled to the system.

According to another embodiment of the present invention, the device further comprises a sheet of material attached to the roller.

According to another embodiment of the present invention, there is provided a method of extending and retracting a sheet of material on a roller comprising: providing a device for extending and retracting a sheet of material comprising: a roller; and a braking mechanism comprising one or more than one housing containing viscous fluid, one or more that one rotor within the housing, a brake connected to the rotor and placed within the housing, the brake comprising a projecting pin, a braking spring wound around the pin of the brake and placed outside the housing where the device further comprises a sheet of material wound around the roller; causing the roller of the device to rotate in a first rotation direction to extend the material attached to the roller; and causing the roller of the device to rotate in a second rotation direction to retract the material attached to the roller, where the rotation of the roller in the second rotation direction actuates the braking mechanism in the device reducing the rate of rotation of the roller, the force of rotation of the roller, or both the rate and force of rotation of the roller, as the roller rotates in the second direction, and where the first rotation direction is the reverse of the second rotation direction.

### FIGURES

These and other features, aspects and advantages of the present invention will become better understood with regard to the following description, appended claims and accompanying figures where:

FIG. 1 is a side perspective view of an embodiment of the braking mechanism according to the present invention; and

FIG. 2 is a side exploded perspective view of the mechanism in FIG. 1.

### DESCRIPTION

According to one embodiment of the present invention, there is provided a braking mechanism designed to reduce the force and rate of rotation of a roller suitable for use with a device for extending and retracting a sheet of material on a roller. According to another embodiment of the present invention, there is provided a device for extending and retracting a sheet of material on a roller. In a preferred embodiment, the device comprises a roller and further comprises a braking mechanism designed to reduce the force and rate of rotation of the roller when the sheet of material is retracted around the roller as compared with conventional devices for extending and retracting a sheet of material on a roller. In a preferred embodiment, the device comprises a braking mechanism according to the present invention. According to another embodiment of the present invention, there is provided a method of extending and retracting a sheet of material on a roller where the force and rate of rotation of the roller is reduced when the sheet of material is retracted around the roller. In a preferred embodiment, the method comprises providing a device according to the present invention. The braking mechanism, device and method will now be discussed in greater detail.

All dimensions specified in this disclosure are by way of example only and are not intended to be limiting. Further, the proportions shown in these Figures are not necessarily to scale. As will be understood by those with skill in the art with reference to this disclosure, the actual dimensions of any device or part of a device disclosed in this disclosure will be determined by its intended use.

In one embodiment, the present invention is a braking mechanism suitable for use with a device for extending and retracting a sheet of material on a roller. The braking mechanism is designed to reduce the force and rate of rotation of the roller when the sheet of material is retracted around the roller as compared with conventional devices for extending and retracting a sheet of material on a roller. The braking mechanism of the present invention is designed for ease of construction in order to reduce manufacturing costs, and is also designed so that, when incorporated in a device for extending and retracting a sheet of material on a roller, the device looks generally like a conventional device for extending and retracting a sheet of material on a roller, and the device can be installed in much the same way as a conventional device in order to be acceptable to an end user as a replacement for a conventional device. In a preferred embodiment, these objectives are accomplished by incorporating the braking mechanism substantially within the roller. Further, the braking mechanism has a resisting force that is inversely proportional to the rotational rate of the roller to increase efficiency when the spring is under high tension, that is, when the device is in the maximally extended position, while not preventing the roller from rotating when the material is nearly completely retracted onto the roller.

In a preferred embodiment, the present invention is a rotating device comprising the braking mechanism of the present invention. In a preferred embodiment, the device comprises a roller and further comprises the braking mechanism of the present invention. In a particularly preferred embodiment, the device is a retractable window shade. In another particularly preferred embodiment, the device is a roller for mosquito netting.

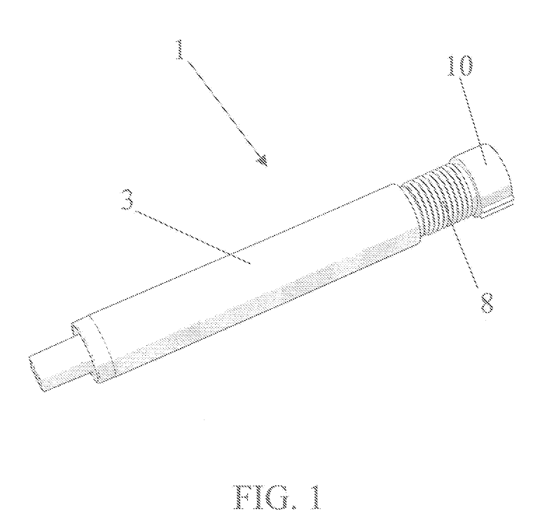

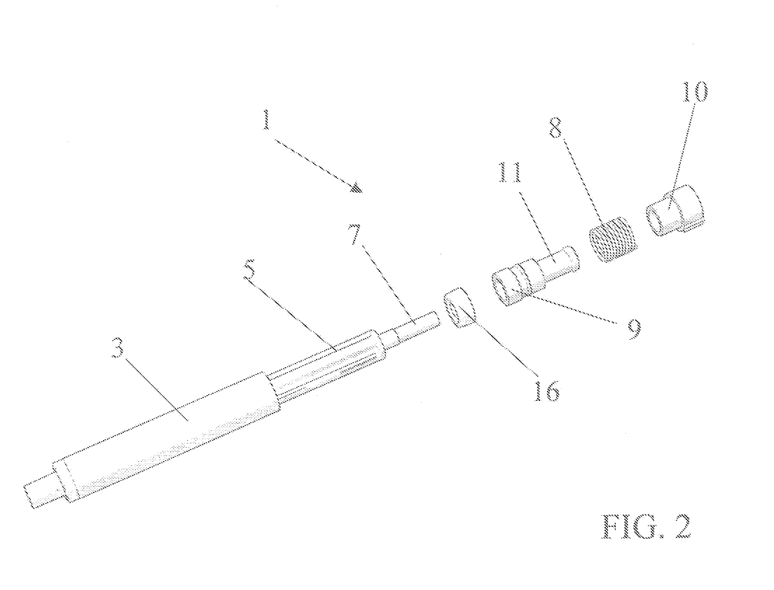

Referring now to FIGS. 1 and 2, there are shown, respectively, a side perspective view of a braking mechanism 1 according to the present invention and a side exploded perspective view of the mechanism shown in FIG. 1. The braking mechanism 1 is monodirectional in order to eliminate friction forces during unwinding. The braking mechanism 1 comprises a housing 3, one or more than one winged rotor 5 within the housing 3 equipped with a projecting support shaft 7 for supporting a brake 9 operatively coupled with the winged rotor 5 through the support shaft 7. The brake 9 is adapted to be operatively coupled with a braking spring 8, in turn coupled with a drum 10. In order to perform such coupling, the brake 9 comprises a projecting pin 11, around which the braking spring 8 is wound.

The housing 3 contains a viscous fluid and substantially surrounds all the main components of the braking mechanism 1 apart from the braking spring 8 and the drum 10, as can be seen in FIG. 1. The housing 3 comprises a clamping member adapted to engage a roller, which is a part of rolling members, in particular for mosquito curtains, around which a cloth is wound, such as for example the net-shaped cloth for a mosquito curtain.

The rotor 5 comprises a plurality of wings that increase turbulence in the viscous fluid and also provide storage room for the viscous fluid inside the housing 3. The brake 9 and the braking spring 8 allow a substantially unhindered rotation of the braking mechanism 1, and therefore the roller, in a first rotation direction of the rotor 5, but make the roller brake through the viscous action of the fluid in the housing 3 when the roller rotates in a second rotation direction, where the second rotation direction is the reverse of the first rotation direction.

The drum 10 is adapted to be coupled with an external system for holding the braking mechanism 1 to a surface or object. In use, the braking mechanism 1 is placed inside the roller, and the drum 10 of the braking mechanism is engaged with the external holding system. The drum 10 surrounds the brake 9 and is attached to the braking spring 8. The drum 10 has a sufficient mechanical resistance externally to be stiffly keyed onto an elastic joint integral with the fixed part of a supporting frame.

As can be seen particularly in FIG. 2, the braking mechanism 1 further comprises one or more than one holder 16 of the viscous fluid that are operatively inserted between rotor 5 and housing 3, to prevent the viscous fluid from leaking out of the braking mechanism 1. In one embodiment, the holder 16 comprises one or more than one gasket, such as for example O-rings, lip seals or labyrinth seals, though other types of holders are also possible, as will be appreciated by one of ordinary skill in the art with reference to this disclosure.

The viscous fluid inside the braking mechanism 1 can be any suitable fluid, as will be appreciated by one of ordinary skill in the art with reference to this disclosure. In a preferred embodiment, the viscous fluid comprises an oil. In one embodiment the viscous fluid comprises high-viscosity oil, for example 100,000 cSt oil. In another embodiment, the viscous fluid comprises a grease as used in some viscous-dynamic brakes in order to make it easier to manufacture the sealing members.

By way of example only, a braking mechanism 1 according to the present invention resists a swinging torsion stress of at least about 0.2 Nm and dissipates a power of about 5 mechanical W during a typical re-winding of about 0.3 m/s, with a braking force of about 15 N. The braking mechanism 1 does not generate excessive heat, either during a single action comprising a braking distance of about 2 m or during repeated actions at its maximum rate.

As will be appreciated by one of ordinary skill in the art with reference to this disclosure, the braking mechanism of the present invention can be used for many applications in many fields. The basic principle of the invention is that the inventive mechanism comprises a kinematic chain; such kinematic chain is composed of the fluido-dynamic braking system and of the fluido-dynamic brake. The fluido-dynamic braking system in turn is composed of a moving part, adapted to transmit force torques with a rightward or leftward movement depending on the situation of the mechanism, namely whether an opening or closing phase of the mechanism occurs. The fluido-dynamic brake in turn is made of a plurality of viscous friction stages, in this case the brake 9 and the braking spring 8.

In one embodiment, the braking mechanism 1 of the invention further comprises a speed multiplier as will be appreciated by one of ordinary skill in the art with reference to this disclosure, such as for example an epicyclic type speed multiplier, placed at the rotor 5 inlet and adapted to increase the rotor 5 rate to obtain a greater braking torque or to permit the use of a lower viscosity oil. The speed multiplier helps the braking torque increase with an increase in the rate of rotation of the rotor, since the rotor rate is greater than the housing rate by an amount that is equal to the reduction ratio. In the particular case of an epicyclic reduction gear, moreover, a reversal of the rotor rotation direction is realized, so that the relative rotor-stator rate will be equal to:

Δω=ωr+ωs*R

where Δω is the angular rotor-housing rate, ωr is the angular rotor rate and ωs is the angular housing rate. Therefore, as will be appreciated by one of ordinary skill in the art with reference to this disclosure, the use of a speed multiplier is particularly desirable where high braking moments have to be obtained in a small space.

This embodiment of the braking mechanism works as follows: when the helical braking spring 8, wound around the pin 11 of the brake 9, is forced to rotate along the same winding direction by an external torque, it loses its grip and lets the brake 9 slide, while when it is forced to rotate in the opposite direction, it is increasingly tightened, thereby blocking the brake 9 itself. In this case, the direction can be easily reversed, replacing a rightward spring with a leftward spring and vice versa. The spring 8 can also function as articulated joint between brake 9 and housing 3.

As will be appreciated by one of ordinary skill in the art with reference to this disclosure, the braking mechanism can be made of any suitable material. In a preferred embodiment, the braking mechanism of the present invention comprises a plastic material, such as for example an acetal homopolymer, and is manufactured through an injection molding technique: this allows cost savings due to scale of production. The plastic construction also allows the parts of the braking mechanism that are subjected to wear to have a more consistent production tolerance and smooth surfaces, which increase the reliability of the braking mechanism.

According to another embodiment of the present invention, there is provided a device for extending and retracting a sheet of material on a roller. In a preferred embodiment, the device comprises a roller and further comprises a braking mechanism designed to reduce the force and rate of rotation of the roller when the sheet of material is retracted around the roller as compared with conventional devices for extending and retracting a sheet of material on a roller. In a preferred embodiment, the device comprises a braking mechanism according to the present invention. In one embodiment, the device further comprises an external system for holding the braking mechanism to a surface or object. In a preferred embodiment, the device comprises a sheet of material attached to the roller.

According to another embodiment of the present invention, there is provided a method of extending and retracting a sheet of material on a roller where the force and rate of rotation of the roller is reduced when the sheet of material is retracted around the roller. In a preferred embodiment, the method comprises providing a device according to the present invention having a sheet of material wound around the roller. The method further comprises causing the roller of the device to rotate in a first rotation direction to extend the material attached to the roller, and then causing the roller of the device to rotate in a second rotation direction to retract the material attached to the roller, where the rotation of the roller in the second rotation direction actuates the braking mechanism in the device reducing the rate of rotation of the roller, the force of rotation of the roller, or both the rate and force of rotation of the roller, as the roller rotates in the second direction, and where the first rotation direction is the reverse of the second rotation direction.

Although the present invention has been discussed in considerable detail with reference to certain preferred embodiments, other embodiments are possible. Therefore, the scope of the appended claims should not be limited to the description of preferred embodiments contained in this disclosure.

1. A monodirectional braking mechanism for use with a device for extending and retracting a sheet of material on a roller, the braking mechanism comprising:
a) one or more than one housing containing viscous fluid;
b) one or more that one rotor within the housing;
c) a brake connected to the rotor and placed within the housing, the brake comprising a projecting pin;
d) a braking spring wound around the pin of the brake and placed outside the housing;
where the braking mechanism reduces the force or rate, or both the force and rate, of rotation of the roller as the roller is rotated in a second rotation direction but has substantially no effect on the force or rate of rotation of the roller when the roller is rotated in a first rotation direction; and
where the first rotation direction is the reverse of the second rotation direction.

2. The braking mechanism of claim 1, where the viscous fluid comprises one or more than one high-viscosity oil.

3. The braking mechanism of claim 1, where the viscous fluid comprises one or more than one grease.

4. The braking mechanism of claim 1, where the rotor comprises a plurality of wings.

5. The braking mechanism of claim 1, further comprising one or more than one holder for the viscous fluid within the housing.

6. The braking mechanism of claim 5, where the holder comprises two or more than two gaskets.

7. The braking mechanism of claim 1, further comprising a speed multiplier connected to the rotor.

8. A device for extending and retracting a sheet of material comprising:
a) a roller; and
b) a braking mechanism according to claim 1.

9. The device of claim 8, further comprising a system for holding the braking mechanism to a surface or object.

10. The device of claim 9, where the braking mechanism further comprises one or more than one drum adapted to be coupled to the system.

11. The device of claim 8, further comprising a sheet of material attached to the roller.

12. A method of extending and retracting a sheet of material on a roller comprising:
a) providing a device according to claim 8, where the device further comprises a sheet of material wound around the roller;
b) causing the roller of the device to rotate in a first rotation direction to extend the material attached to the roller; and
c) causing the roller of the device to rotate in a second rotation direction to retract the material attached to the roller;
where the rotation of the roller in the second rotation direction actuates the braking mechanism in the device reducing the rate of rotation of the roller, the force of rotation of the roller, or both the rate and force of rotation of the roller, as the roller rotates in the second direction; and
where the first rotation direction is the reverse of the second rotation direction.
